(19) United States
(12) Patent Application Publication
(10) Pub. No.: US 2024/0159566 A1
(43) Pub. Date: May 16, 2024

(54) STEP COUNTING METHOD AND DEVICE, ELECTRONIC APPARATUS AND READABLE STORAGE MEDIUM

(71) Applicant: GOERTEK INC., Weifang, Shandong (CN)

(72) Inventors: Yanhua TANG, Weifang, Shandong (CN); Xue YANG, Weifang, Shandong (CN)

(21) Appl. No.: 18/552,242

(22) PCT Filed: Nov. 1, 2021
(86) PCT No.: PCT/CN2021/127824

§ 371 Date: Sep. 25, 2023

(30) Foreign Application Priority Data
Jun. 25, 2021 (CN) 202110712793.X

(51) Int. Cl. G01C 22/00

(52) U.S. Cl. CPC G01C 22/006

(57) ABSTRACT

A step counting method and device, an electronic apparatus and a computer-readable storage medium are disclosed. The method comprises: obtaining resultant acceleration and detecting peaks of the resultant acceleration to obtain a plurality of peak time points; calculating respective time intervals between adjacent two peak time points; if the time interval is in a first range, increasing the step count by one; if the time interval is in a second range, selecting sensitive axis data from three-axis gyroscope data; and if the sensitive axis data corresponding to the time interval meets a step counting condition, increasing the step count by two.

The present application claims the priority of the Chinese Patent Application No. 202110712793.X, entitled “step counting method and device, electronic apparatus and readable storage medium” filed with China Patent Office on Jun. 25, 2021, the entire contents of which are incorporated into the present disclosure by reference.

### TECHNICAL FIELD

The present disclosure relates to a technical field of an intelligent terminal device, and more particularly, to a step counting method, a step counting device, an electronic apparatus and a computer-readable storage medium.

### DESCRIPTION OF RELATED ART

Step counting is a process of obtaining the number of walking steps of a user by data collecting, analyzing and determining by a terminal. In the related art, an accelerometer is typically adopted to perform step counting. During walking, arms and a body of the user will swing back and forth, and up and down, and generated acceleration data is regular, which is different from those generated in non-walking state. Therefore, methods such as peak detection, threshold detection, correlation coefficient detection, frequency domain detection etc. are performed on the acceleration value obtained by the accelerometer to obtain a valid peak value. If the valid peak value meets a set of certain preset standards (for example, a threshold condition, a time condition, etc.), it may be recognized as a valid step, and the step count increased by one. However, in the related art, step detection is not accurately performed in particular situations. For example, it is inconsistent between swinging back and swinging forth during walking for some users, which leads to a difficult or inaccurate of the peak of the acceleration, and thus leads to a problem of inaccurate step counting.

Therefore, the problem of inaccurate step counting in the related art is a technical problem that needs to be solved.

### SUMMARY

In view of this, a purpose of the present disclosure is to provide a step counting method, a step counting device, an electronic apparatus and a computer-readable storage medium, which may perform step counting accurately and improve the accuracy of step counting.

To solve the above technical problem, the present disclosure provides a step counting method, comprising: obtaining resultant acceleration and detecting peaks of the resultant acceleration to obtain a plurality of peak time points; calculating respective time intervals between adjacent two peak time points, if the time interval is in a first range, increasing a step count by one, if the time interval is in a second range, selecting sensitive axis data from three-axis gyroscope data, and if the sensitive axis data corresponding to the time interval meets a step counting condition, increasing the step count by two.

Optionally, the three-axis gyroscope data comprises X-axis data, Y-axis data and Z-axis data, and wherein the selecting sensitive axis data from three-axis gyroscope data comprises: obtaining sensitive axis information, and determining the X-axis data, the Y-axis data or the Z-axis data corresponding to the sensitive axis information as the sensitive axis data.

Optionally, obtaining sensitive axis information comprises: calculating a sum of historical absolute values of the X-axis data, the Y-axis data and the Z-axis data within a preset time period based on a target time point, respectively, and determining axis information corresponding to the largest one of the sums as the sensitive axis information.

Optionally, obtaining sensitive axis information comprises: obtaining target axis information, and determining the target axis information as the sensitive axis information.

Correspondingly, the method further comprises: determining whether an update cycle is reached; and if the update cycle is reached, updating the target axis information based on the X-axis data, the Y-axis data and the Z-axis data.

Optionally, if the sensitive axis data corresponding to the time interval meets the step counting condition, the increasing the step count by two comprising: obtaining an extreme value of the sensitive axis data; performing a zero-crossing detection on the sensitive axis data to obtain the number of zero-crossing points; and if the extreme value is in an extreme value range and the number of the zero-crossing points is equal to two, determining that the step counting condition is met and increasing the step count by two.

Optionally, obtaining an extreme value of the sensitive axis data comprises: obtaining a maximum value and a minimum value of the sensitive axis data.

Correspondingly, if the extreme value is in an extreme value range and the number of the zero-crossing points is equal to two, determining that the step counting condition is met comprises: if the maximum value is in a maximum period, the minimum value is in a minimum period, and the number of the zero-crossing points is equal to two, determining that the step counting condition is met.

Optionally, obtaining resultant acceleration and detecting peaks of the resultant acceleration to obtain a plurality of peak time points comprises: obtaining three-axis acceleration data, and obtaining the resultant acceleration using the three-axis acceleration data; detecting maximum values of the resultant acceleration to obtain initial peak time points; and filtering out invalid peaks from the initial peak time points to obtain the peak time points.

The present disclosure also provides a step counting device, comprising: a peak detection module for obtaining resultant acceleration and detecting peaks of the resultant acceleration to obtain a plurality of peak time points; an interval determination module for calculating respective time intervals between adjacent two peak time points; a first step counting module for increasing a step count by one if the time interval is in a first range; a data selecting module for selecting sensitive axis data from three-axis gyroscope data if the time interval is in a second range; and a second step counting module for increasing the step count by two if the sensitive axis data corresponding to the time interval meets the step counting condition.

The present disclosure also provides an electronic apparatus comprising a memory and a processor, wherein the memory is used to store a computer program, and wherein the processor is used to execute the computer program to achieve the above step counting method.

The present disclosure also provides a computer-readable storage medium used to store a computer program, wherein the above step counting method is achieved when the computer program is executed by a processor.

The step counting method of the present disclosure comprises: obtaining resultant acceleration and detecting peaks of the resultant acceleration to obtain a plurality of peak time points; calculating respective time intervals between adjacent two peak time points; if the time interval is in a first range, increasing the step count by one; if the time interval is in a second range, selecting sensitive axis data from three-axis gyroscope data; and if the sensitive axis data corresponding to the time interval meets a step counting condition, increasing the step count by two.

Thus, this method detects the peaks of the resultant acceleration after obtaining the resultant acceleration, and records the times corresponding to peak data, respectively, i.e., the peak time points. As the swing arm frequency is in a certain range during walking, the time interval between adjacent two peak time points is also in a certain range under normal condition. The first range refers to a time interval that is enough to fast walk one step but not enough to fast walk two steps. If the time interval is in the first range, it means only walking one step, and there is no missing detected peak between the two peaks, so one step is counted. The second range refers to a time interval that is enough to fast walk two steps or enough to slow walk one step. If the time interval is in the second range, it means that there may be missing detected peaks between the two peaks that constitute the time interval, that is, it might be walking two steps within the time interval. Three-axis gyroscope data may detect the swing angle during walking in three mutually perpendicular directions, and the sensitive axis data is the most sensitive data for swing during walking. By selecting the sensitive axis data and determining the step counting condition, it may be detected whether there are missing detected peaks in the time interval. If the step counting condition is met, it means there is a missing peak in the time interval, the user walked two steps in the time interval, so two steps are counted. By using the acceleration and the three-axis gyroscope data together to perform step counting, it may detect a situation that missing detection of the peak in the detection for the peak of acceleration is occurred due to small swing amplitude etc., and thus to perform step counting accurately and to improve the accuracy of step counting, to solve the problem of inaccurate step counting in the related art.

In addition, the present disclosure also provides a step counting device, an electronic apparatus and a computer-readable storage medium, which also has the above beneficial effects.

### BRIEF DESCRIPTION OF DRAWINGS

In order to clear and fully illustrate technical solutions according to embodiments of the present disclosure or the related art, the drawings are used in the description of embodiments or the prior art will be introduced briefly as following. Obviously, the drawings in the following description are merely exemplary and for those of ordinary skill in the art, other drawings may also be obtained from the provided drawings without any creative labor.

FIG. 1 is a flow chart of a step counting method according to the embodiment of the present disclosure;

FIG. 2 is an acceleration waveform graph according to the embodiment of the present disclosure;

FIG. 3 is a schematic diagram of a detection result of the peak of acceleration according to the embodiment of the present disclosure;

FIG. 4 is a waveform graph gyroscope data according to the embodiment of the present disclosure;

FIG. 5 is a schematic diagram of a detection result of a three-axis gyroscope according to the embodiment of the present disclosure;

FIG. 6 is a specific waveform graph of step counting according to the embodiment of the present disclosure;

FIG. 7 is a structural diagram of a step counting device according to the embodiment of the present disclosure; and

FIG. 8 is a structural diagram of an electronic apparatus according to the embodiment of the present disclosure.

### DETAILED DESCRIPTIONS

In order to make the purpose, the solution and the advantage of the embodiments of the present disclosure clearer, the solution of the embodiments of the present disclosure will be described clearly and completely in combination with the drawings of the embodiments of the present disclosure. Obviously, the described embodiments are only a part of the embodiments of the present disclosure, but not all of the embodiments. Based on the embodiments in the present disclosure, all other embodiments obtained by those skilled in the art without creative labor fall within the protection scope of protection in the present disclosure.

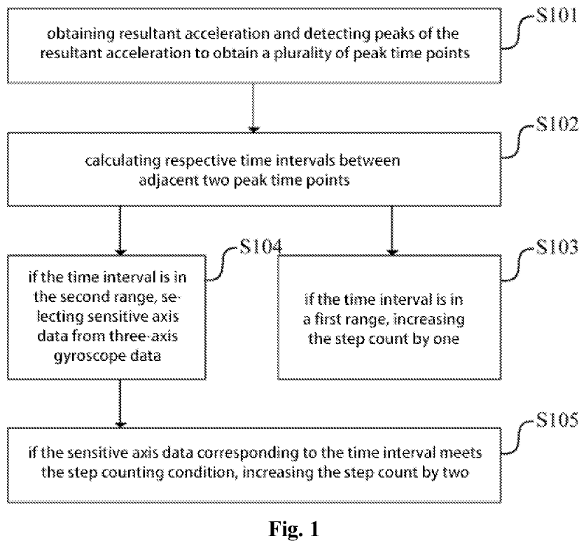

FIG. 1 is the flow chart of a step counting method according to the embodiment of the present disclosure. As illustrated in FIG. 1, the method comprises the following steps.

S101: obtaining resultant acceleration and detecting peaks of the resultant acceleration to obtain a plurality of peak time points.

The resultant acceleration refers to the total acceleration obtained by calculating based on component accelerations in multiple different directions. According to walking habits of different users, the arm swing direction may be any direction in space. In order to accurately determine whether the user is walking, the resultant acceleration is required to be obtained to determine the peak values. This embodiment is not limited to the specific method of obtaining the resultant acceleration. In one embodiment, the resultant acceleration may be directly measured by an acceleration sensor. In another embodiment, multiple component accelerations may be obtained, and the resultant acceleration may be calculated from the component accelerations.

It should be understood that, generally, components such as the acceleration sensor etc. detects the accelerations in different directions, for example, acceleration values in respective axes of a three dimensional coordinate system. In order to represent the current acceleration in the three-dimensional space of the object, it is required to calculate the resultant acceleration by using the respective component accelerations in the three direction axes.

After the resultant acceleration is obtained, the peaks thereof are obtained, i.e., the peaks in a waveform graph of the resultant acceleration are detected, and the times corresponding to peaks are determined as the peaks. Since the arms of a user swing changes from slow to fast and then fast to slow during walking, correspondingly, the acceleration changes from increasing to decreasing. Therefore, by peak detection, it may be determined whether the user is in a walking state. It should be noted that the peaks in this embodiment refer to acceleration maximum values caused by swinging the arms during walking. According to different peak detection methods, the numbers and specific contents of the peaks corresponding to the same resultant acceleration curve may be different, and the corresponding peak time points may also be different.

This embodiment is not limited to the specific method for detection peaks. For example, in an embodiment, any maximum points may be taken as the peaks; in another embodiment, the maximum points greater than a threshold value may be taken as the peaks; and in another embodiment, in order to improve the detection accuracy, to obtain the resultant acceleration, and to detect the peaks of the resultant acceleration, the process of obtaining a plurality of peak time points may comprise the following steps.

Step 11: obtaining three-axis acceleration data, and obtaining the resultant acceleration using the three-axis acceleration data.

Step 12: detecting a maximum value of the resultant acceleration to obtain initial peak time points.

Step 13: filtering out invalid peaks from the initial peak time points to obtain peak time points.

The three-axis acceleration data refers to acceleration data obtained based on the three directional axes of the three-dimensional rectangular coordinate system. In this embodiment, the resultant acceleration may be expressed as acc_norm, and the component accelerations in respective coordinates are expressed as acc_x, acc_y and acc_z, which represent the component acceleration in a X-axis direction, the component acceleration in a Y-axis direction and the component acceleration in a Z-axis direction, respectively, and constitute the above three-axis acceleration data together. In this case, the resultant acceleration is:

acc_norm=sqrt(acc_x∧2+acc_y∧2+acc_z∧2)

That is, the square root of the sum of the squares of the above three component accelerations is the resultant acceleration. FIG. 2 is an acceleration waveform graph according to the embodiment of the present disclosure. In FIG. 2, the solid curve is a composite acceleration curve, the dotted curve is an X-axis acceleration curve, the dashed curve is a Y-axis acceleration curve, and the dot-dashed curve is a Z-axis acceleration curve. It should be noted that the above formula for calculating the resultant acceleration may only be used on the precondition that the X axis, the Y axis and the Z axis are perpendicular to each other. If this precondition is not met, other methods should be used to calculate the resultant acceleration.

After the resultant acceleration is obtained, the maximum values thereof are detected, and the detected maximum values are determined as the initial peaks, and the corresponding times are determined as the initial peak time points. As the resultant acceleration waveform has not been smoothed, there might be many noise maximum values that will cause interference. In order to improve the accuracy and reliability of peak detection and to further improve the accuracy of step counting, it is required to detect whether each initial peak is valid and to filter out invalid initial peaks as well as the corresponding initial peak time points, to obtain the peak time points.

For the specific way for filter out invalid peaks, in an embodiment, the time condition may be set in advance, to determine whether the time interval between two adjacent maximum points is less than the preset threshold value after the maximum points are detected. If it is less than the threshold value, one of them is select as the peak and the other one is discarded. In another embodiment, on the basis of the above time conditions, a threshold condition may also be set in advance. That is, the initial peaks which has a maximum point data less than a certain threshold value are filtered out. On the basis of filtering out such initial peaks, determination of the above time conditions is performed. That is, it is determined whether the time interval between two adjacent maximum points is less than the threshold value, if it is less than the threshold value, one of them is selected as the peak. For example, the larger one is selected as the peak, the corresponding initial peak is a peak time point, and the other one is discarded.

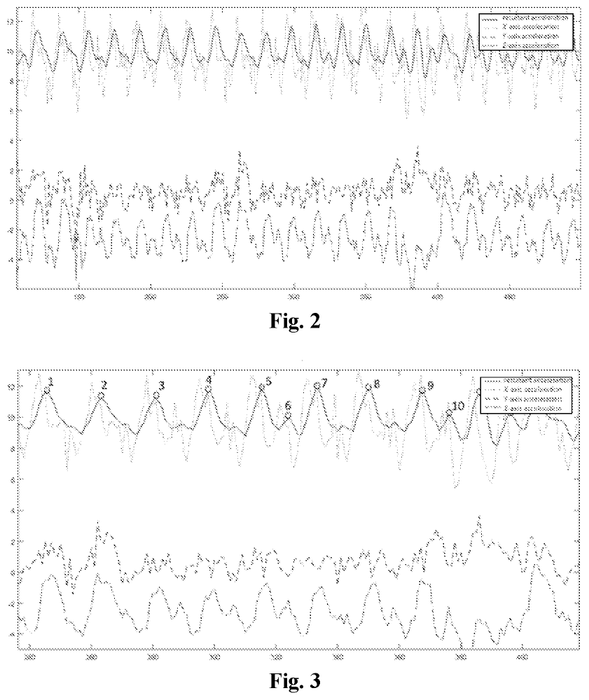

By obtaining all the maximum values as the initial peaks and filtering out the initial peaks based on specific filtering conditions, the detection accuracy of the peaks and the peak time points may be improved, and thus the step counting accuracy may be improved. FIG. 3 is a schematic diagram of a detection result of the peak of acceleration according to the embodiment of the present disclosure. In FIG. 3, the circles indicated by serial number 1, 2 . . . and so on are the peak points, and corresponding horizontal axis is the sampling point serial number. Because the new sampling is carried out according to the preset time, the sampling point serial number may only correspond to a certain time on the time axis, which is the peak time point corresponding to the peak point.

S102: calculating respective time intervals between adjacent two peak time points.

After obtaining the peak time points, the time interval between adjacent two peak time points is calculated. The time interval may represent the time between the two steps corresponding to the two peaks.

In step counting according to a conventional method, after two adjacent peaks are detected, if the time interval between the adjacent two peak time points corresponding to the detected two adjacent peaks is within the time range of one normal step, it is determined that one step is detected, and one step is counted. For details, referring to FIG. 3. In FIG. 3, the peak point indicated by serial number 1 and the peak point indicated by serial number 2 correspond to the peak time point indicated by serial number 1 and the peak time point indicated by serial number 2, respectively. If the time interval between them is within the time range of one normal step, one step will be added according to the conventional step counting method.

However, if the arms swing during walking is different from that in the normal situation, for example, the forward swing amplitude is larger than the backward swing amplitude, or vise verse, and so one. In these cases, the small swing amplitude will make the corresponding resultant acceleration small, insulting in a small peak. Referring to FIG. 3 again, there is a relatively smaller maximum point between the peak point indicated by serial number 1 and the peak point indicated by serial number 2. In addition, the same situation also occurred between the peak point indicated by serial number 2 and the peak point indicated by serial number 3, between the peak point indicated by serial number 3 and the peak point indicated by serial number 4, between the peak point indicated by serial number 4 and the peak point indicated by serial number 5, and between the subsequent peak points. As the maximum values of these maximum points are smaller and are not recognized as peak points, two steps are recorded as one step during step counting, resulting in an inaccurate step counting.

In order to solve the above problems, after obtaining the time interval, perform different operations according to the different ranges of the time interval, detect whether there are the above special situations, and perform the following steps.

S103: if the time interval is in a first range, increasing the step count by one.

The first range refers to the period with the minimum time of one step (may be expressed as t1) as a lower limit value, and the minimum time of two steps (may be expressed as t2) as an upper limit value. The minimum time of the one step means a minimum time interval between the first step and the second step in a normal walking, and the minimum time of the two steps means a minimum time interval between the first step and the third step in a normal walking.

If the time interval is in the first range, it means that there is a possibility for only one step, and it is impossible for two steps, thus it may be determined that the above special situation is not possible. Therefore, one step is counted, and the step counting is completed.

S104: if the time interval is in the second range, selecting sensitive axis data from three-axis gyroscope data.

The second range refers to the period with the minimum time of two steps (i.e., t2) as a lower limit value and the maximum time of one step (may be expressed as t3) as an upper limit value. The maximum time of the one step refers to a maximum time interval between the first step and the second step in a normal walking. If the time interval is in the second range, it means that the above special condition may occur in current situation, so it is necessary to further determine whether the above special condition occurs. It should be noted that this embodiment is not limited to the specific values of t1, t2 and t3. In one embodiment, t1=200 ms, t2=300 ms, t3=2000 ms may be set.

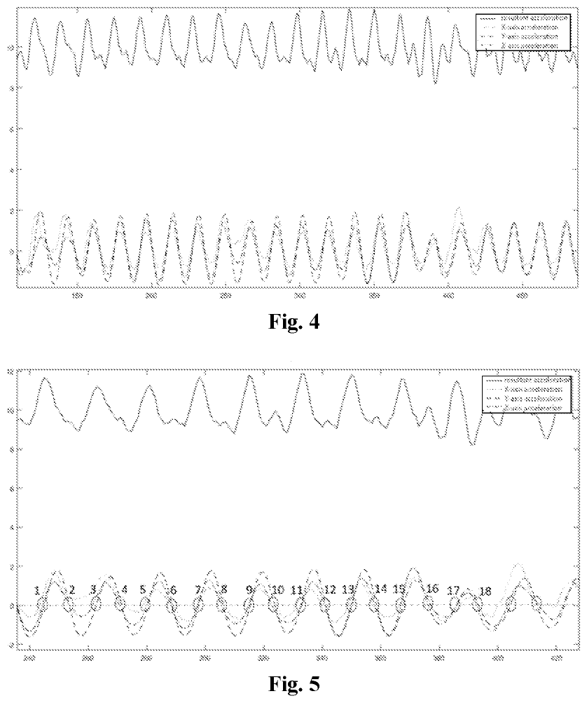

Three-axis gyroscope data refers to gyroscope data obtained based on three directional axes of the space rectangular coordinate system. Specifically, the gyroscope data is angular velocity data. It can be understood that the three-axis gyroscope data and acceleration data is associated with time, so it may be considered that the three-axis gyroscope data and the acceleration data at the same time have corresponding relationship. Sensitive axis data refers to the data most sensitive to the arm swing in current situation. By filtering out the sensitive axis data from the three-axis gyroscope data, the data insensitive to the arm swing may be excluded from the three-axis gyroscope data, and then the sensitive axis data may be used to determine the arm swing situation accurately. FIG. 4 is a waveform graph gyroscope data according to the embodiment of the present disclosure. Referring to FIG. 4, the solid curve is the resultant acceleration curve, the point-like curve is the X-axis angular velocity curve (that is, the gyroscope data in the X-axis direction, which may be expressed as gyro_x), the dashed curve is the Y-axis angular velocity curve (which may be expressed as gyro_y), and the dot-dashed curve is the Z-axis angular velocity curve (which may be expressed as gyro_z). It may be understood that the sensitive axis data corresponds to the sensitive axis, so the process of selecting the sensitive axis data from the three-axis gyroscope data may comprise the following steps.

Step 21: obtaining the sensitive axis information, and determining the X-axis data, the Y-axis data or the Z-axis data corresponding to the sensitive axis information as the sensitive axis data.

Herein, the sensitive axis information means the information that a data axis in the space rectangular coordinate system is a sensitive axis, and the content thereof is the information that uniquely matches the data axis. After the sensitive axis information is obtained, the X-axis data, the Y-axis data or the Z-axis data thereof are determined as the sensitive axis data. Since the three data axes are vertical with each other, when one of them is sensitive to motion, the other two may be insensitive to motion, so there may be only one sensitive axis.

For the method of obtaining the sensitive axis information, in an embodiment, in order to ensure determining the sensitive axis accurately, the sensitive axis information may be obtained in real time when it is required to determine the sensitive axis. The process of obtaining the sensitive axis information may comprise the following steps.

Step 31: calculating a sum of historical absolute values of the X-axis data, the Y-axis data and the Z-axis data within a preset time period based on a target time point, respectively, and determining axis information corresponding to the largest one of the sums as the sensitive axis information.

Herein, the target time point refers to a reference time for determining a starting time and an ending time of a preset time, which may be any of the two adjacent peak time points. FIG. 5 is a schematic diagram of a detection result of a three-axis gyroscope according to the embodiment of the present disclosure. Referring to FIG. 5, the X-axis data, the Y-axis data and the Z-axis data will change to be positive and negative according to the different front and rear directions of the swing arm movement, and zero-crossing points will be appeared. In a period of time, data corresponding to which data axis has the maximum absolute sum, which data axis is most sensitive to the swing arm movement, it is because acting the same swing arm movement, the maximum swing speed and the maximum amplitude may be detected in the data axis direction.

Therefore, in a determined target time point, which is determined as the end of the preset time or the start of the preset time, and the absolute sum of the X-axis data, the Y-axis data, and the Z-axis data from the start time to the end time is calculated, to obtain the historical absolute sums corresponding the three data axes, respectively. By determining the maximum historical absolute value sum, that is, the largest one of the absolute value sum, and by determining the corresponding axis information as the sensitive axis information, obtaining of the sensitive axis information is completed. Axis information refers to the information that is determined matches the data axis uniquely, for example, it may be the name of the data axis, that is, the X axis, the Y axis or the Z axis, or it may be the number of the data axis, such as the first axis, the second axis, and the third axis.

In the second embodiment, in order to improve the speed of step counting, the predetermined target axis information may be directly obtained as the sensitive axis information. That is, the steps to obtain the sensitive axis information may comprise the following step.

Step 41: obtaining target axis information and determining the target axis information as the sensitive axis information.

Herein, the target axis information is a predetermined axis information. When obtaining the sensitive axis information, it may be directly used as the sensitive axis information. As the sensitive axis may be changed during walking, it is required to update the target axis information according to certain rules.

Correspondingly, the method further comprises the following steps.

Step 42: determining whether the target axis information update cycle is reached.

Step 43: if the target axis information update cycle is reached, updating the target axis information based on the X-axis data, the Y-axis data and the Z-axis data.

Specifically, the update cycle refers to a time period of updating the target axis information. This embodiment is not limited to the specific values of the update interval. For example, it may be updated every 2 s. That is, the target axis information is updated every two seconds. During operation, it may be determined whether the update cycle is reached in real time, and the target axis information is updated based on the X-axis data, the Y-axis data and the Z-axis data after the update cycle is reached. The specific update method may refer to the record corresponding to step 31, or it may adopt other updated method.

S105: if the sensitive axis data corresponding to the time interval meets the step counting condition, increasing the step count by two.

After obtaining the sensitive axis data, it is determined whether a part of the sensitive axis data corresponding to the time interval determined by peak detection above meets the step counting condition. The step counting condition refers to the condition that the sensitive axis data records the characteristics of walking two steps, and the specific content thereof is not limited. As the direction of angular velocity may change when the direction of the swing arm changes during walking, which is reflected in the sensitive axis data that the data changes to be positive and negative. So, if the user walked two steps, there should be two changes, and the two changes will cause two zero-crossing points in the continuous sensitive axis data. Therefore, the step counting condition may be set as whether there are two zero-crossing points.

In another embodiment, in order to further improving the step counting accuracy and preventing an interference movement from interfering with the step counting, the swing arm has a certain amplitude during movement, which is reflected in the sensitive axis data that the data value is large. Therefore, if the sensitive axis data corresponding to the time interval meets the step counting condition, the process of increasing the step count by two may comprise the following steps.

Step 51: obtaining an extreme value of the sensitive axis data.

Step 52: performing a zero-crossing detection on the sensitive axis data to obtain the number of zero-crossing points.

Step 53: if the extreme value is in an extreme value range and the number of the zero-crossing points is equal to two, determining that the step count condition is met and increasing the step count by two.

The number of the zero-crossing points may be determined by the detection of the zero-crossing point, and the maximum amplitude of arm swing may be determined by obtaining the extreme value. When the extreme value is in an extreme period, it means that the swing amplitude of the arm is large, and the detected movement is unlikely to be a noise signal, and if the number of the zero-crossing points is two, it may be determined that the user walked two steps, so two steps may be counted.

Further, in order to maximize the accuracy of the step counting, the process of obtaining the extreme value of the sensitive axis data comprises the following steps.

Step 61: obtaining a maximum value and a minimum value of the sensitive axis data.

Correspondingly, if the extreme value is in an extreme value range and the number of the zero-crossing points is equal to two, determining that the step counting condition is met further comprise the following steps.

Step 62: if the maximum value is in a maximum period, the minimum value is in a minimum period, and the number of the zero-crossing points is equal to two, determining that the step counting condition is met.

In this embodiment, obtained extreme value comprises the maximum value and the minimum value. In determination, it is determined whether the maximum value is in the corresponding maximum period and whether the minimum value is in the corresponding minimum period. Only when the maximum value is in the maximum period, the minimum value is in the minimum period, and the number of the zero-crossing points is equal to two, it is determined that the step counting condition is met. This embodiment is not limited to the specific values of the maximum period and the minimum period. For example, in one embodiment, the maximum period may be set as [1.5rad/s, +∞], and the minimum period may be set as [−∞, −1.5rad/s].

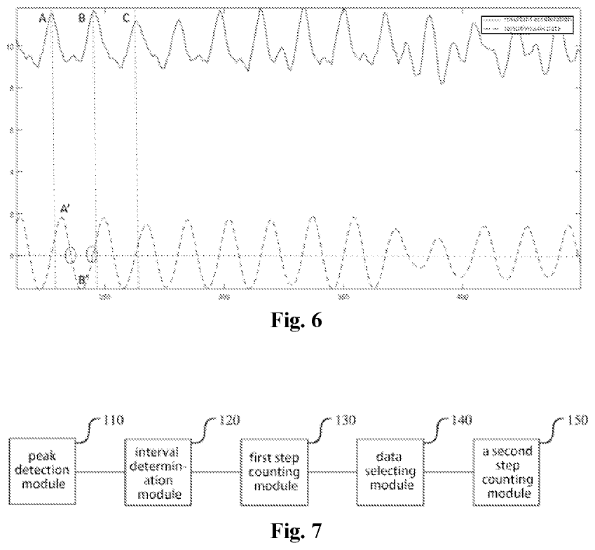

FIG. 6 is a specific waveform graph of step counting according to the embodiment of the present disclosure. Referring to FIG. 6, the time interval between a peak point A and a peak point B is calculated after they are detected. If the time interval is in the second range, obtain the sensitive axis data and the extreme value, so as to obtain the maximum value A′ and the minimum value B′. A′ is in the maximum value and B′ is in the minimum value. At the same time, two zero-crossing points are obtained by zero-crossing detection. In this situation, it may be determined that the step counting condition is met. Although the peak between the peak point A and the peak point B is not detected by peak detection of the resultant acceleration, it may be determined that the user walked two steps instead of one step, so two steps are counted.

It should be noted that if the time interval is not in the first range or the second range, it may be considered that the user is not in a walking state, so the step counting may not be performed. If the time interval is in the second range, but does not meet the step counting condition, in this case, in order to ensure the accuracy of the step counting, step counting may not be performed, or other operations may be performed, the embodiment is not limited thereto.

By applying the step counting method provided in the embodiment of the present disclosure, this method detects the peaks of the resultant acceleration after obtaining the resultant acceleration, and records the times corresponding to peak data, respectively, i.e., the peak time points. In a normal condition, as the swing arm frequency is in a certain range during walking, the time interval between adjacent two peak time points is also in a certain range. The first range refers to a time interval that is enough to fast walk one step but not enough to fast walk two steps. If the time interval is in the first range, it means the user only walked one step, and there is no undetected peak between the two peaks, so one step is counted. The second range refers to a time period that is enough for two steps in fast walking or enough to for one step in slow walking. If the time interval is in the second range, it means that there may be a missing detected peak between the two peaks that during the time interval. That is, user walked two steps within the time period. Three-axis gyroscope data may detect the swing angle during walking in three mutually perpendicular directions, and the sensitive axis data is the most sensitive data for swing during walking. By selecting the sensitive axis data and determining the step counting condition, it may be detected whether there are missing detected peaks during the time period. If the step counting condition is met, it means there is a missing peak in the time interval, the user walked two steps during this time period, so two steps are counted. By using the acceleration and the three-axis gyroscope data together to perform step counting, it may determine a missing detected peak of acceleration is occurred due to small swing amplitude etc., and thus to perform step counting accurately and to improve the accuracy of step counting, to solve the problem of inaccurate step counting in the related art.

The step counting device according to the embodiment of the present disclosure is described below. The step counting device described below and the step counting method described above may be referred to each other.

FIG. 7 is a structural diagram of a step counting device according to the embodiment of the present disclosure. Referring to FIG. 7, the step counting device comprises: a peak detection module 110 for obtaining resultant acceleration and detecting peaks of the resultant acceleration to obtain a plurality of peak time points; an interval determination module 120 for calculating respective time intervals between adjacent two peak time points; a first step counting module 130 for increasing the step count by one if the time interval is in the first range; a data selecting module 140 for selecting the sensitive axis data from the three-axis gyroscope data if the time interval is in the second range; and a second step counting module 150 for increasing the step count by two if the sensitive axis data corresponding to the time interval meets the step counting condition.

Optionally, the three-axis gyroscope data comprises the X-axis data, the Y-axis data and the Z-axis data, and the data selecting module 140 comprises: a filtering unit for obtaining sensitive axis information and determining the X-axis data, the Y-axis data or the Z-axis data corresponding to the sensitive axis information as the sensitive axis data.

Optionally, the filtering unit comprises: an absolute value calculation sub-unit for calculating a sum of historical absolute value of the X-axis data, the Y-axis data and the Z-axis data within a preset time period based on a target time point, respectively, and determining axis information corresponding to the largest one of the sums as the sensitive axis information.

Optionally, the filtering unit comprises: obtaining sub-unit for obtaining target axis information and determining the target axis information as the sensitive axis information;

Accordingly, the filtering unit further comprises: a cycle determination module for determining whether an update cycle is reached; and an information updating module for updating the target axis information based on the X-axis data, the Y-axis data and the Z-axis data if the update cycle is reached.

Optionally, the second step counting module 150 comprises: an extreme value obtaining unit for obtaining an extreme value of the sensitive axis data; a zero-crossing point detection unit for performing a zero-crossing detection on the sensitive axis data to obtain the number of zero-crossing points; and a step counting unit for determining that the step counting condition is met and increasing the step count by two if the extreme value is in an extreme value range and the number of the zero-crossing points is equal to two.

Optionally, the extreme value obtaining unit comprises: a maximum value and minimum value obtaining unit for obtaining a maximum value and a minimum values of the sensitive axis data.

Correspondingly, the step counting unit comprises: a period matching sub-unit for determining that the step counting condition is met if the maximum value is in a maximum value range, the minimum value is in a minimum value range, and the number of the zero-crossing points is equal to two.

Optionally, the peak detection module 110 comprises: a resultant acceleration calculation unit for obtaining three-axis acceleration data, and obtaining the resultant acceleration using the three-axis acceleration data; an initial detection unit for detecting maximum values of the resultant acceleration to obtain initial peak time points; and a filtering unit for filtering out invalid peaks from the initial peak time points to obtain the peak time points.

The electronic apparatus according to the embodiment of the present disclosure is described below. The electronic apparatus described below and the step counting method described above may be referred with each.

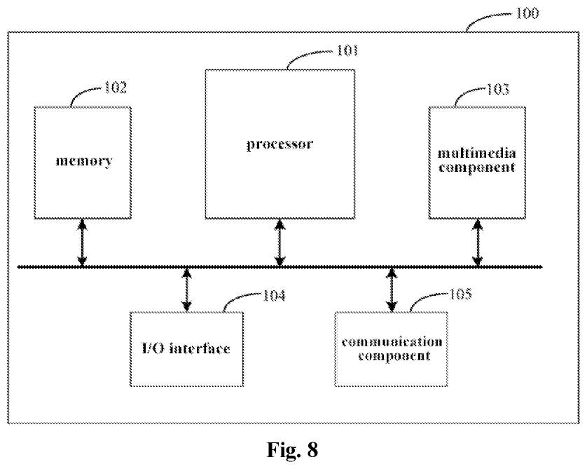

FIG. 8 is a structural diagram of an electronic apparatus according to the embodiment of the present disclosure. Referring to FIG. 8, the electronic apparatus 100 may comprise a processor 101 and a memory 102, and may further comprise one or more of a multimedia component 103, an information input/information output (I/O) interface 104 and a communication component 105.

Herein, the processor 101 is used to control the overall operation of the electronic apparatus 100 to achieve all or part of the steps in the step counting method described above. The memory 102 is used to store various types of data to support the operation on the electronic apparatus 100. For example, these data may comprise instructions for any application or method operated on the electronic apparatus 100, and data related to the application. The memory 102 may be implemented by any type of volatile or non-volatile storage device or their combination, such as one or more of static random access memory (SRAM), electrically erasable programmable Read-Only memory (EEPROM), erasable programmable Read-Only memory (EPROM), Programmable Read-Only Memory (PROM), Read-Only Memory (ROM), magnetic memory, flash memory, disk or optical disk.

The multimedia component 103 may comprise a screen and an audio component. For example, the screen may be a touch screen, and the audio component is used to output and/or input audio signals. For example, the audio component may comprise a microphone for receiving external audio signals. The received audio signal may be further stored in the memory 102 or transmitted through the communication component 105. The audio component further comprises at least one speaker for outputting audio signals. The I/O interface 104 provides an interface between the processor 101 and other interface modules, which may be keyboard, mouse, button, etc. These buttons may be virtual or physical buttons. The communication component 105 is used for wired or wireless communication between the electronic apparatus 100 and other devices. Wireless communication may be, such as Wi-Fi, Bluetooth, Near Field Communication (NFC), 2G, 3G or 4G, or a combination of one or more of them, so the corresponding communication component 105 may comprise Wi-Fi component, Bluetooth component, NFC component.

The electronic apparatus 100 may be achieved by one or more Application Specific Integrated Circuit (ASIC), Digital Signal Processor (DSP), Digital Signal Processing Device (DSPD), Programmable Logic Device (PLD) Field programmable gate array (FPGA), controller, microcontroller, microprocessor or other electronic components to perform the step counting method given in the above embodiment.

The computer-readable storage medium according to the embodiment of the present disclosure is described below. The computer-readable storage medium described below and the step counting method described above may be referred to each other.

The present disclosure also provides a computer-readable storage medium on which a computer program is stored, and the steps of the step counting method described above are achieved when the computer program is executed by the processor.

The computer-readable storage media may comprise: USB flash disk, removable hard disk, Read-Only Memory (ROM), Random Access Memory (RAM), magnetic disk or optical disk and other media that may store program code.

Each embodiment in this specification is described in a progressive manner. Each embodiment focuses on the differences from other embodiments. The same or similar parts between each embodiment may be referred to each other. For the device disclosed in the embodiment, because it corresponds to the method disclosed in the embodiment, the description is relatively simple. Referring to the description of the method section for details.

Those skilled in the art may also further realize that the units and algorithm steps of each example described in combination with the embodiments disclosed herein may be realized by electronic hardware, computer software or a combination of the two. In order to clearly illustrate the interchangeability of hardware and software, the composition and steps of each example are described in general terms of function in the above description. Whether these functions are implemented in hardware or software depends on the specific application and design constraints of the technical solution. Those skilled in the art may use different methods to achieve the described functions for each specific application, but such implementation should not be considered beyond the scope of the present disclosure.

The steps of the method or algorithm described in combination with the embodiments disclosed herein may be directly implemented by hardware, software modules executed by processors, or a combination of the two. The software module may be placed in random access memory (RAM), memory, read-only memory (ROM), electrically programmable ROM, electrically erasable programmable ROM, register, hard disk, removable disk, CD-ROM, or any other form of storage medium known in the technical field.

Finally, it should also be noted that in this specification, relationships such as the first and second are only used to distinguish one entity or operation from another entity or operation, and do not necessarily require or imply any such actual relationship or order between these entities or operations. Moreover, the term comprise, include or any other variation is intended to cover non-exclusive inclusion, so that a process, method, article or equipment that comprises a series of elements not only comprises those elements, but further comprises other elements that are not explicitly listed, or further comprises elements inherent in such process, method, article or equipment.

In the present disclosure, specific examples are used to explain the principle and implementation of the present disclosure. The above examples are only used to help understand the method and core idea of the present disclosure. At the same time, for those skilled in the art, according to the idea of the present disclosure, there will be changes in the specific implementation mode and application scope. To sum up, the contents of this specification should not be understood as restrictions on the present disclosure.

1. A step counting method, comprising:
obtaining resultant acceleration and detecting peaks of the resultant acceleration to obtain a plurality of peak time points;
calculating respective time intervals between adjacent two peak time points,
if the time interval is in a first range, increasing a step count by one,
if the time interval is in a second range, selecting sensitive axis data from three-axis gyroscope data; and
if the sensitive axis data corresponding to the time interval meets a step counting condition, increasing the step count by two.

2. The step counting method according to claim 1, wherein the three-axis gyroscope data comprises X-axis data, Y-axis data and Z-axis data, and
wherein the selecting sensitive axis data from three-axis gyroscope data comprises:
obtaining sensitive axis information; and
determining the X-axis data, the Y-axis data or the Z-axis data corresponding to the sensitive axis information as the sensitive axis data.

3. The step counting method according to claim 2, wherein obtaining sensitive axis information comprises:
calculating respective sums of historical absolute values of the X-axis data, the Y-axis data and the Z-axis data within a preset time period based on a target time point, and
determining axis information corresponding to the largest one of the sums as the sensitive axis information.

4. The step counting method according to claim 2, wherein obtaining sensitive axis information comprises obtaining target axis information, and determining the target axis information as the sensitive axis information, and
wherein the method further comprises:
determining whether an update cycle is reached; and
if the update cycle is reached, updating the target axis information based on the X-axis data, the Y-axis data and the Z-axis data.

5. The step counting method according to claim 1, wherein if the sensitive axis data corresponding to the time interval meets the step counting condition, the increasing the step count by two comprising:
obtaining an extreme value of the sensitive axis data;
performing a zero-crossing detection on the sensitive axis data to obtain a number of zero-crossing points; and
if the extreme value is in an extreme value range and the number of the zero-crossing points is equal to two, determining that the step counting condition is met and increasing the step count by two.

6. The step counting method according to claim 5, wherein obtaining an extreme value of the sensitive axis data comprises obtaining a maximum value and a minimum value of the sensitive axis data, and
wherein if the extreme value is in an extreme value range and the number of the zero-crossing points is equal to two, determining that the step counting condition is met comprises:
if the maximum value is in a maximum period, the minimum value is in a minimum period, and the number of the zero-crossing points is equal to two, determining that the step counting condition is met.

7. The step counting method according to claim 1, wherein obtaining resultant acceleration and detecting peaks of the resultant acceleration to obtain a plurality of peak time points comprises:
obtaining three-axis acceleration data, and obtaining the resultant acceleration using the three-axis acceleration data;
detecting maximum values of the resultant acceleration to obtain initial peak time points; and
filtering out invalid peaks from the initial peak time points to obtain the peak time points.

8. A step counting device, comprising:
a peak detection module for obtaining resultant acceleration and detecting peaks of the resultant acceleration to obtain a plurality of peak time points;
an interval determination module for calculating respective time intervals between adjacent two peak time points;
a first step counting module for increasing a step count by one if the time interval is in a first range;
a data selecting module for selecting sensitive axis data from three-axis gyroscope data if the time interval is in a second range; and
a second step counting module for increasing the step count by two if the sensitive axis data corresponding to the time interval meets the step counting condition.

9. An electronic apparatus comprising:
a memory to store a computer program; and
a processor to execute the computer program to achieve the step counting method of claim 1.

10. A non-transitory computer-readable storage medium used for store a computer program, wherein the step counting method of claim 1 is achieved when the computer program is executed by a processor.
